(19) United States
(12) Patent Application Publication
(10) Pub. No.: US 2011/0254972 A1
(43) Pub. Date: Oct. 20, 2011

(54) IMAGING DEVICE

(75) Inventor: Yoshitaka YAGUCHI, Osaka (JP)

(73) Assignee: Panasonic Corporation, Osaka (JP)

(21) Appl. No.: 13/071,456

(22) Filed: Mar. 24, 2011

(30) Foreign Application Priority Data
Mar. 26, 2010 (JP) 2010-072003
Mar. 23, 2011 (JP) 2011-064072

(51) Int. Cl. H04N 5/228

(52) U.S. Cl. 348/222.1; 348/E05.031

(57) ABSTRACT

An imaging device is provided that includes an imaging component, a cropper, a monitor, and a warning component. The imaging component is configured to generate frame image data by capturing a subject image. The cropper is configured to generate cropped image data used to produce a cropped image. The cropped image data is generated based on a cropped region of a frame image produced according to the frame image data. The monitor is configured to display a through-image by sequentially displaying the cropped images based on the cropped image data. The warning component is configured to issue a warning when the cropped region overlaps a specific portion of the frame image.

### CROSS-REFERENCE TO RELATED APPLICATIONS

This application claims priority to Japanese Patent Application No. 2010-072003, filed on Mar. 26, 2010, and Japanese Patent Application No. 2011-064072, filed on Mar. 23, 2011. The entire disclosure of Japanese Patent Application No. 2010-072003 and Japanese Patent Application No. 2011-064072 are hereby incorporated herein by reference.

### BACKGROUND

1. Technical Field

The technological field relates to an imaging device that zooms a specific imaging target for display.

2. Description of the Related Art

A method in which a specific imaging target (hereinafter referred to as “specific target”; one example being a human face) detected from a through-image of the imaging area is zoomed for display on a monitor of an imaging device has been proposed in the past (see Japanese Laid-Open Patent Application 2009-147727).

With this method, as long as the specific target is within the imaging area, an image including the zoomed specific target can be automatically displayed and acquired.

### SUMMARY

When a zoomed specific target is displayed on the monitor, as noted above in the aforementioned prior art reference, it has been discovered that it is difficult for the user to recognize that the specific target may have been formed outside of the imaging area. Therefore, there is the risk that the specific target will suddenly be formed outside of the imaging area.

One object of the technology disclosed herein is to provide an imaging device in which a user can be notified that a specific target may have been formed outside of the imaging area.

In accordance with one aspect of the technology disclosed herein, an imaging device is provided that includes an imaging component, a cropper, a monitor, and a warning component. The imaging component is configured to generate frame image data by capturing a subject image. The cropper is configured to generate cropped image data used to produce a cropped image. The cropped image data is generated based on a cropped region of a frame image produced according to the frame image data. The monitor is configured to display a through-image by sequentially displaying the cropped images based on the cropped image data. The warning component is configured to issue a warning when the cropped region overlaps a specific portion of the frame image

With the technology disclosed herein, an imaging device can be provided with which a user can be notified that a specific target may be framed out of the imaging area.

These and other features, aspects and advantages of the technology disclosed herein will become apparent to those skilled in the art from the following detailed description, which, taken in conjunction with the annexed drawings, discloses a preferred and example embodiments of the present invention.

### BRIEF DESCRIPTION OF DRAWINGS

Referring now to the attached drawings which form a part of this original disclosure:

FIG. 1 is a block diagram of the constitution of a digital video camera 100 pertaining to a first embodiment;

FIG. 2 is a block diagram of the functions of an imaging processor 190 pertaining to the first embodiment;

FIG. 3 is a schematic diagram of a frame image A;

FIG. 4 is a schematic diagram of a recording image B;

FIG. 5 is a schematic diagram of a displaying image C;

FIG. 6 is a schematic diagram of a cropped region Y and an annular rectangle region Z;

FIG. 7 is a flowchart illustrating the operation of the digital video camera 100;

FIG. 8 is a schematic diagram of the cropped region Y and the annular rectangle region Z;

FIG. 9 is a schematic diagram of the displaying image C and a warning image D;

FIG. 10 is a block diagram of the functions of an imaging processor 190A pertaining to a second embodiment;

FIG. 11 is a schematic diagram of the displaying image C and a reduced frame image E; and

FIG. 12 is a schematic diagram of the displaying image C, the reduced frame image E, and the warning image D.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

In the following, a digital video camera will be described through reference to the drawings as an example of an “imaging device”. The technology disclosed herein is not limited to a digital video camera, though, and can also be applied to a digital still camera, a portable telephone, or another such device having a still or moving picture recording function.

In the following description, “up,” “down,” “left,” and “right” are terms used in reference to a digital video camera with a landscape orientation and facing a subject head on. “Landscape orientation” is that orientation in which the long-side direction of a captured image coincides with the horizontal direction in the captured image.

### First Embodiment

(1-1) Electrical Configuration of Digital video Camera 100

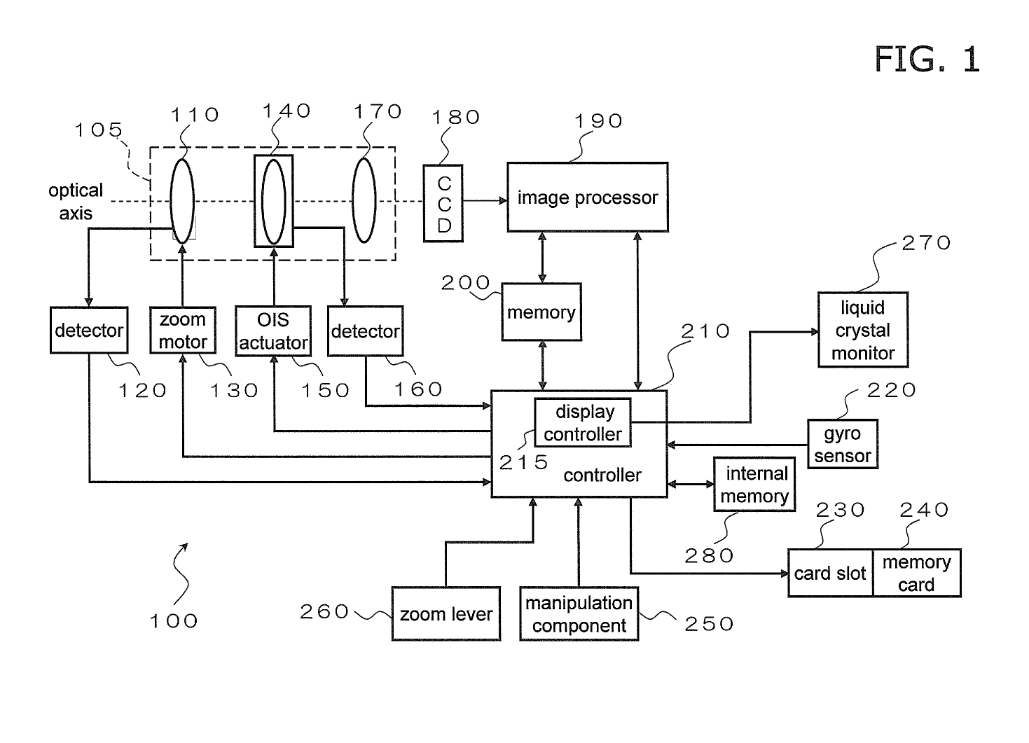

The electrical configuration of the digital video camera 100 pertaining to a first embodiment will be described through reference to FIG. 1. FIG. 1 is a block diagram of the constitution of the digital video camera 100.

The digital video camera 100 captures a subject image provided by an optical system 105, with a CCD image sensor 180 (an example of an “imaging component”). The frame image data generated by the CCD image sensor 180 undergoes various kinds of image processing by an imaging processor 190. A “through-image” is displayed on a liquid crystal monitor 270 on the basis of the frame image data that has undergone this image processing, and the frame image data that has undergone this image processing is stored on a memory card 240. The “through-image” is a moving picture displayed on the liquid crystal monitor 270 by the successive display of a plurality of displaying images C (see FIG. 5, discussed below). The user uses this through-image to determine the composition of the subject. The through-image itself is usually not stored on the memory card 240.

The configuration of the digital video camera 100 will now be described in detail.

The optical system 105 includes a zoom lens 110, an OIS 140, and a focus lens 170. The zoom lens 110 is able to enlarge or reduce the subject image by moving along the optical axis of the optical system 105. The focus lens 170 adjusts the focus of the subject image by moving along the optical axis of the optical system 105. The OIS 140 houses a correcting lens that is able to move in a plane perpendicular to the optical axis. The OIS 140 reduces blurring of the subject image by driving the correcting lens in a direction that cancels out shake of the digital video camera 100.

A detector 120 detects the position of the zoom lens 110 on the optical axis. The detector 120 outputs a signal indicating the position of the zoom lens 110 via a brush or other such switch according to the movement of the zoom lens 110 in the optical axis direction. A zoom motor 130 drives the zoom lens 110. The zoom motor 130 may be a pulse motor, a DC motor, a linear motor, a servo motor, or the like. The zoom motor 130 may drive the zoom lens 110 via a cam mechanism, a ball screw, or another such mechanism. An OIS actuator 150 drives the correcting lens within the OIS 140 in a plane perpendicular to the optical axis. The OIS actuator 150 can be a planar coil, an ultrasonic motor, or the like. Also, a detector 160 detects the amount of movement of the correcting lens housed in the OIS 140.

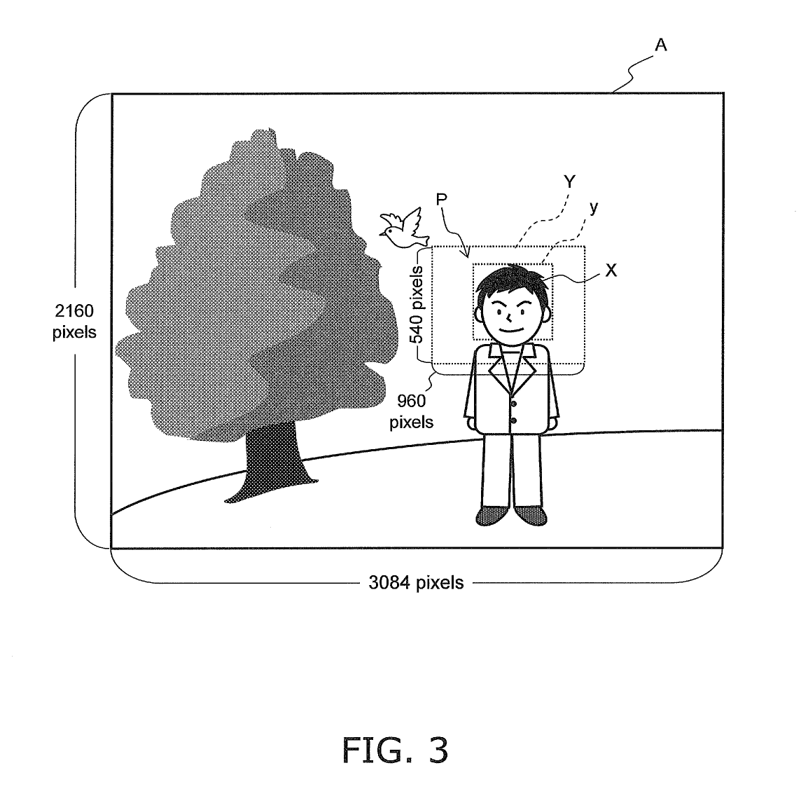

The CCD image sensor 180 captures the subject image provided by the optical system 105, and sequentially generates frame image data in time series order. The frame image data is image data corresponding to a frame image A (discussed below; see FIG. 3). The CCD image sensor 180 can perform exposure, transfer, electronic shuttering, and other such operations.

The imaging processor 190 subjects the frame image data generated by the CCD image sensor 180 to various kinds of image processing. More specifically, the imaging processor 190 generates displaying image data for display on the liquid crystal monitor 270 on the basis of frame image data, and outputs the result to a controller 210. The imaging processor 190 generates recording image data for storage on the memory card 240, and outputs this to a memory 200. Also, the imaging processor 190 subjects frame image data to gamma correction, white balance correction, scratch correction, and other such image correction processing. The image processor 190 also compresses the frame image data using a compression format that conforms to the MPEG2 standard, the H.246 standard, or the like. The image processor 190 can be a DSP, a microprocessor, or the like.

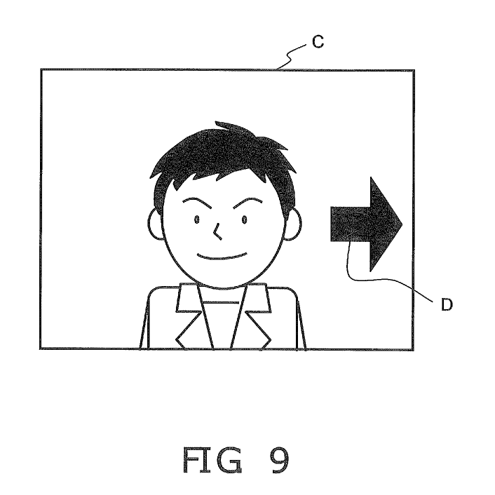

The controller 210 is a control means for controlling the entire digital video camera 100. In this embodiment, the controller 210 has a display controller 215 (an example of a “warning component”). The display controller 215 sequentially displays on the liquid crystal monitor 270 displaying images C (see FIG. 5) corresponding to the displaying image data generated by the imaging processor 190. Consequently, the through-image is displayed on the liquid crystal monitor 270. Also, the display controller 215 displays a warning image D (see FIG. 9) corresponding to warning image data (discussed below) along with the through-image on the liquid crystal monitor 270. When a manipulation member 250 (discussed below) receives a start recording command, the controller 210 records the recording image data stored in the memory 200 on the memory card 240. This controller 210 can be a semiconductor element or the like. The controller 210 may be constituted by hardware alone, or by a combination of hardware and software. The controller 210 can be a microprocessor or the like.

The memory 200 functions as a working memory for the image processor 190 and the controller 210. The memory 200 is a DRAM, a ferroelectric memory, or the like, for example.

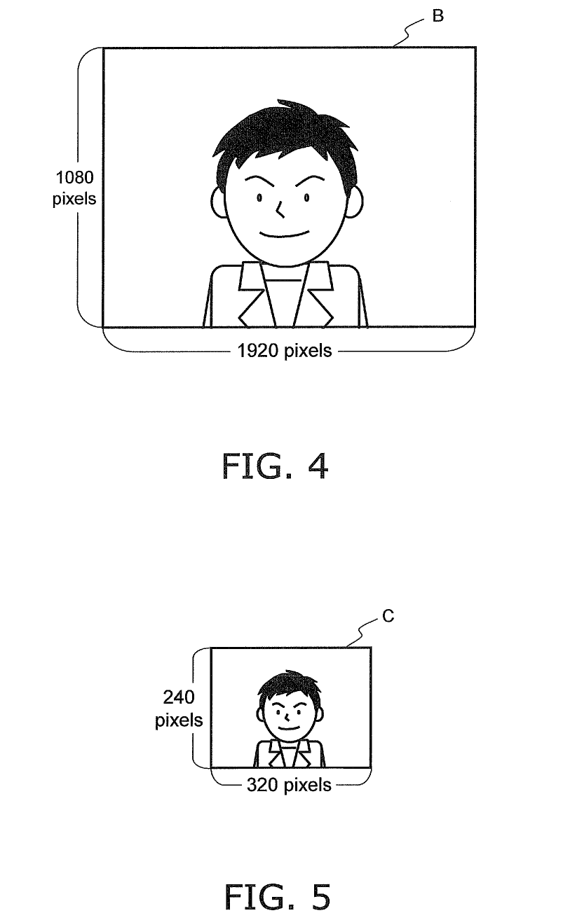

The liquid crystal monitor 270 (an example of a “monitor”) is able to display a displaying image C corresponding to the displaying image data generated by the imaging processor 190, and a recording image B (see FIG. 4) corresponding to the recording image data read out from the memory card 240. In this embodiment, the liquid crystal monitor 270 has a resolution corresponding to the displaying image C (320 pixels horizontal×240 pixels vertical). Accordingly, when the recording image B (1920 pixels horizontal×1080 pixels vertical) is displayed on the liquid crystal monitor 270, the recording image B is subjected to processing to lower the resolution. Also, the liquid crystal monitor 270 displays the warning image D along with the through-image.

A gyro sensor 220 is constituted by a piezoelectric element or another such vibrating material. The gyro sensor 220 obtains angular velocity information by converting the Coriolis force exerted on the vibrating material, which is vibrated at a specific frequency, into voltage. The controller 210 drives the correcting lens inside the OIS 140 in the direction of canceling out the shake of the digital video camera 100 on the basis of angular velocity information from the gyro sensor 220. Consequently, any camera shake by shaking of the user's hand is corrected.

A card slot 230 has an insertion opening for inserting and removing the memory card 240. The card slot 230 can be mechanically and electrically connected to the memory card 240. The memory card 240 includes an internal flash memory, ferroelectric memory, etc., and is able to store data.

An internal memory 280 is constituted by a flash memory, a ferroelectric memory, or the like. The internal memory 280 holds control programs and so forth for controlling the entire digital video camera 100.

The manipulation member 250 is a member that is manipulated by the user. The manipulation member 250 includes a mode selector button for selecting between an imaging mode in which a subject image is captured, and a reproduction mode in which the recording image data is reproduced. When the imaging mode has been selected, the through-image is displayed in real time on the liquid crystal monitor 270. Also, the manipulation member 250 includes a record button that is used to start and stop recording.

A zoom lever 260 is a member that receives zoom ratio change commands from the user.

(1-2) Function of Imaging Processor 190

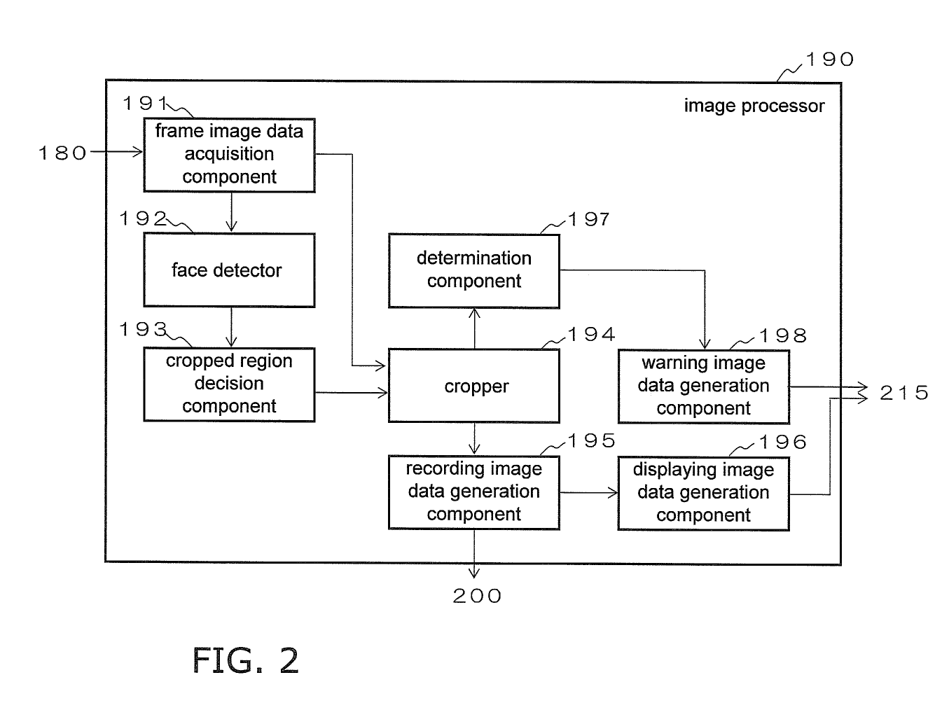

The main functions of the imaging processor 190 pertaining to this embodiment will be described through reference to FIGS. 2 to 6. FIG. 2 is a block diagram of the functions of the imaging processor 190. FIGS. 3 to 6 are schematic diagrams of images corresponding to various image data obtained by the imaging processor 190.

The imaging processor 190 has a frame image data acquisition component 191, a face detector 192, a cropped region decision component 193, a cropper 194, a recording image data generation component 195, a displaying image data generation component 196, a determination component 197, and a warning image data generation component 198.

The frame image data acquisition component 191 detects that the manipulation member 250 has been operated so as to select the imaging mode. The frame image data acquisition component 191 acquires frame image data in real time from the CCD image sensor 180 according to detection that the imaging mode has been selected. The frame image data acquisition component 191 outputs the frame image data to the face detector 192 and the cropper 194.

As shown in FIG. 4, the face detector 192 (an example of a “specific target detector”) detects the position and size of a human face X (an example of a “specific target”) from the frame image A corresponding to the frame image data. The frame image A pertaining to this embodiment has a size of 3084 pixels horizontal×2160 pixels vertical, but the face detector 192 can use a reduced image of the frame image A to perform detection processing on the face X in order to reduce the processing load.

As shown in FIG. 3, the cropped region decision component 193 decides the position and size of a cropped region Y on the basis of the position and size of the human face X detected by the face detector 192. The cropped region decision component 193 can decide the cropped region Y by enlarging a rectangular region y that surrounds the human face X two times horizontally and vertically, for example. The cropped region Y pertaining to this embodiment has a size of 960 pixels horizontal×540 pixels vertical.

The cropper 194 generates cropped image data corresponding to a cropped image P by cropping out the cropped image P included in the cropped region Y from the frame image A. The cropper 194 outputs the cropped image data to the recording image data generation component 195.

The recording image data generation component 195 generates recording image data on the basis of the cropped image data. As shown in FIG. 4, the recording image B corresponding to recording image data has a size of 1920 pixels horizontal×1080 pixels vertical. Specifically, in this embodiment, the recording image B is an image obtained by subjecting the cropped image P to enlargement two times horizontal and vertical. The recording image data generation component 195 outputs the recording image data to the displaying image data generation component 196. The recording image data generation component 195 also stores recording image data in the memory 200 when it is detected that the manipulation member 250 has been operated to start recording.

The displaying image data generation component 196 generates displaying image data on the basis of recording image data. As shown in FIG. 5, the displaying image C corresponding to displaying image data has a size of 320 pixels horizontal×240 pixels vertical. Specifically, the displaying image C is an image obtained by subjecting the recording image B to reduction processing. The displaying image data generation component 196 outputs the displaying image data thus generated to the display controller 215.

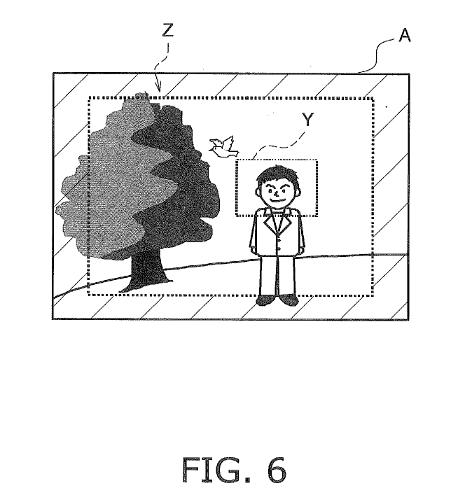

As shown in FIG. 6, the determination component 197 determines whether or not the cropped region Y in the frame image A overlaps an annular rectangle region Z (an example of the “specific portion of the frame image A”; the hatched region in FIG. 6). In this embodiment, the annular rectangle region Z is a region within a specific distance from the outer edge of the frame image A. The determination component 197 determines that the two are overlapping even if only a part of the cropped region Y overlaps the annular rectangle region Z. That is, the determination component 197 determines that the two are overlapping if none of the cropped region Y lies within the annular rectangle region Z. If it is determined that the cropped region Y and the annular rectangle region Z are overlapping, the determination component 197 notifies the warning image data generation component 198 whether the cropped region Y is overlapping at the top, bottom, left, or right of the annular rectangle region Z. On the other hand, if it is determined that the cropped region Y is not overlapping the annular rectangle region Z, the determination component 197 sends no notification to the warning image data generation component 198.

The warning image data generation component 198 generates warning image data corresponding to the warning image D for directing a change in the imaging direction according to notification by the determination component 197. For instance, the warning image data generation component 198 generates warning image data corresponding to a right arrow if a notification has been received to the effect that the cropped region Y overlaps the right side of the annular rectangle region Z. The warning image data generation component 198 outputs the warning image data thus generated to the display controller 215. In response, the display controller 215 displays the warning image D along with the through-image on the liquid crystal monitor 270 (see FIG. 9).

(1-3) Operation of Digital video Camera 100

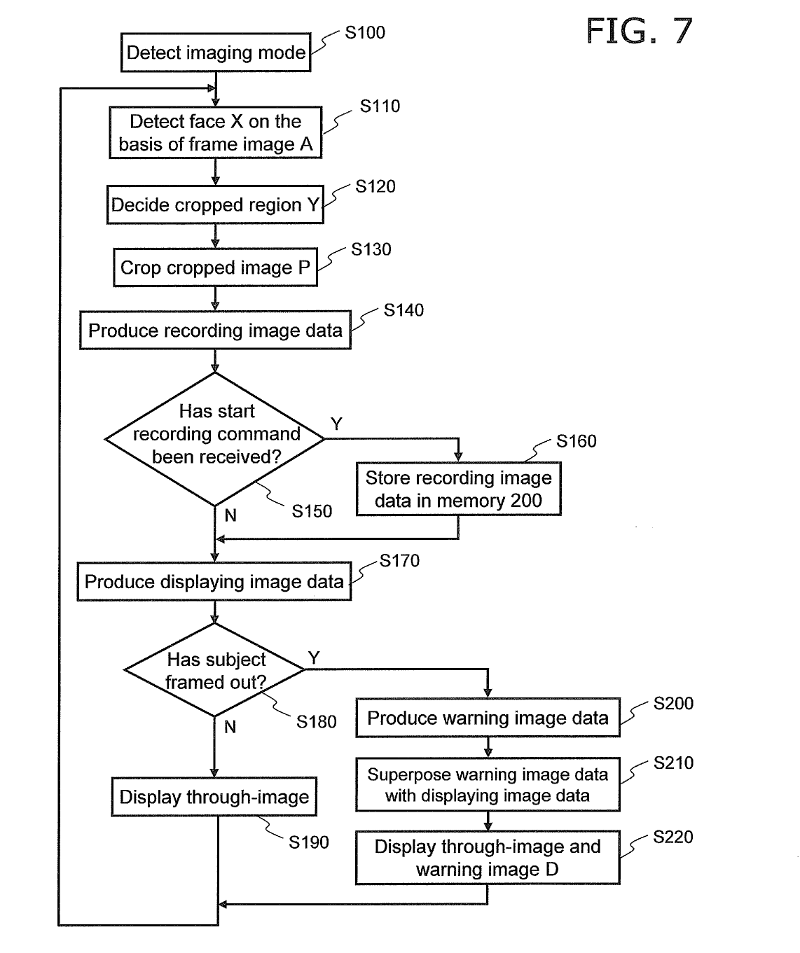

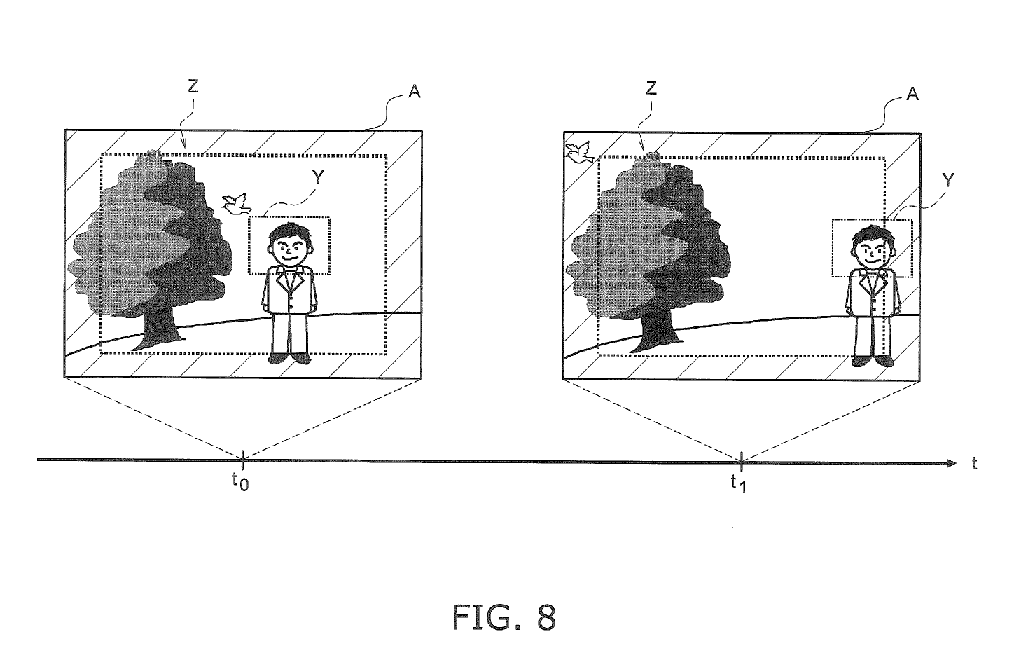

The operation of the digital video camera 100 will now be described through reference to FIGS. 7 to 9. FIG. 7 is a flowchart illustrating the operation of the digital video camera 100. FIG. 8 is a schematic diagram of the positional relation between the cropped region Y and the annular rectangle region Z. FIG. 9 is a schematic diagram of the displaying image C and the warning image D.

In step S100, the imaging processor 190 detects the selection state of the imaging mode.

In step S110, the imaging processor 190 detects the position and size of the face X from the frame image A corresponding to frame image data (see FIG. 3).

In step S120, the imaging processor 190 decides the position and size of the cropped region Y on the basis of the position and size of the face X (see FIG. 3).

In step S130, the imaging processor 190 crops out the cropped image P included in the cropped region Y from the frame image A.

In step S140, the imaging processor 190 generates recording image data corresponding to the recording image B on the basis of cropped image data (see FIG. 4).

In step S150, the imaging processor 190 determines whether or not the user has performed a manipulation to start recording. If it has been performed, the processing proceeds to step S170 via step S160. If it has not been performed, the processing proceeds to step S170.

In step S160, the imaging processor 190 stores recording image data in the memory 200.

In step S170, the imaging processor 190 generates displaying image data corresponding to the displaying image C on the basis of recording image data (see FIG. 5). The imaging processor 190 also outputs displaying image data to the controller 210.

In step S180, the imaging processor 190 determines whether or not the cropped region Y in the frame image A is overlapping the annular rectangle region Z. As shown at time t0 in FIG. 8, if the cropped region Y is not overlapping the annular rectangle region Z, the processing proceeds to step S 190. As shown at time t1 in FIG. 8, if the cropped region Y overlapping the annular rectangle region Z, the processing proceeds to step S200.

In step S190, the controller 210 displays a through-image on the liquid crystal monitor 270 on the basis of displaying image data. After this, the processing returns to step S110.

In step S200, the imaging processor 190 generates warning image data corresponding to the warning image D directing a change in the imaging direction. The imaging processor 190 also outputs warning image data to the controller 210.

In step S210, the controller 210 generates superposed image data by superposing warning image data with displaying image data.

In step S220, the controller 210 displays the warning image D along with the through-image on the liquid crystal monitor 270 on the basis of the superposed image data, as shown in FIG. 9. After this, the processing returns to step S110.

In this embodiment, as shown at the time t1 in FIG. 8, since the cropped region Y is overlapping the right portion of the annular rectangle region Z, there is a high probability that the human face X will be framed out to the right of the frame image A. Accordingly, a right arrow, which prompts adjustment of the imaging direction to the right, is selected as the warning image D.

(1-4) Action and Effect

With the digital video camera 100 pertaining to a first embodiment, the display controller 215 (an example of a “warning component”) displays the warning image D (an example of a “warning”) along with the through-image on the liquid crystal monitor 270 if the cropped region Y is overlapping the annular rectangle region Z (an example of the “specific portion of the frame image A”).

Accordingly, even if an enlarged zoom display is in progress, by watching the displaying image C displayed on the liquid crystal monitor 270, the user can be notified that there is the risk of the face X being framed out.

### Second Embodiment

(2)

Next, a digital video camera 100A pertaining to a second embodiment will be described through reference to the drawings. In the following description, the differences from the digital video camera 100 pertaining to the first embodiment above will mainly be described.

(2-1) Function of Imaging Processor 190A

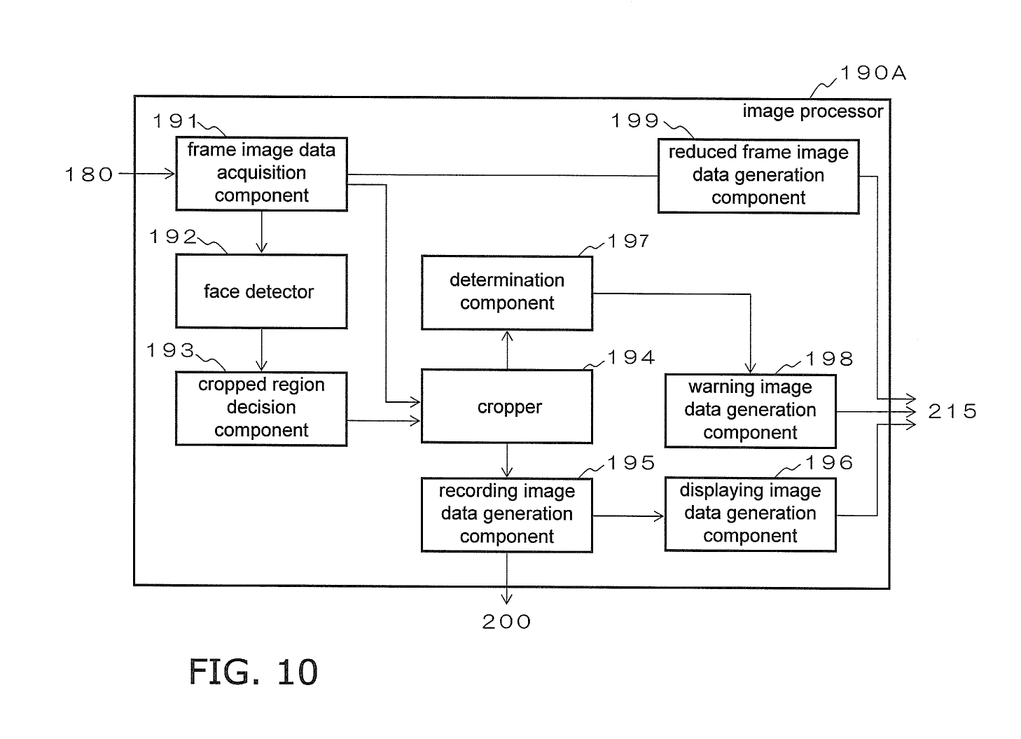

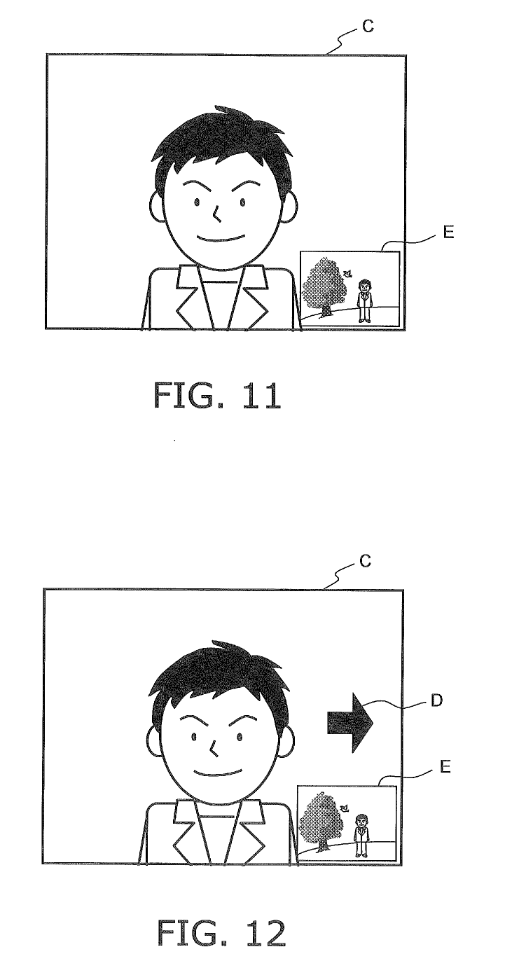

The main functions of the imaging processor 190A pertaining to this embodiment will be described through reference to FIGS. 10 to 12. FIG. 10 is a block diagram of the functions of the imaging processor 190A. FIGS. 11 and 12 are schematic diagrams of images corresponding to image data acquired by the imaging processor 190A.

The imaging processor 190A has a reduced frame image data generation component 199 in addition to the constitution of the imaging processor 190 pertaining to the first embodiment above.

The reduced frame image data generation component 199 acquires frame image data from the frame image data acquisition component 191. The reduced frame image data generation component 199 generates reduced frame image data indicating a reduced frame image E (obtained by reducing the frame image A) on the basis of the frame image data. The reduced frame image data generation component 199 outputs the reduced recording image data to the display controller 215.

As shown in FIG. 11, the display controller 215 in this case displays the reduced frame image E along with the displaying image C on the liquid crystal monitor 270. Also, as shown in FIG. 12, the display controller 215 displays the warning image D along with the displaying image C and the reduced frame image E on the liquid crystal monitor 270 if warning image data has been acquired.

(2-2) Action and Effect

With the digital video camera 100A pertaining to this second embodiment, the display controller 215 displays the reduced frame image E along with the through-image on the liquid crystal monitor 270.

Accordingly, the user can be made aware ahead of time by watching the reduced frame image E that the face X may be framed out, and can confirm the proper imaging direction from the reduced frame image E.

### Other Embodiments

First and second embodiments were described above, the present invention is not limited to or by these. In view of this, other embodiments of the present invention will be collectively described in this section.

(A) The optical system 105 pertaining to the above-mentioned embodiments was constituted by the zoom lens 110, the OIS 140, and the focus lens 170, but is not limited to this. The optical system 105 may be constituted by one or two lenses, and may also be constituted by four or more lenses.

(B) Also, in the above embodiments, the CCD image sensor 180 was given as an example of an imaging component, but the present invention is not limited to this. For example, a CMOS image sensor or an NMOS image sensor can be used as the imaging component.

(C) Also, in the above embodiments, a memory card was given as an example of a recording medium, but the present invention is not limited to this. For example, the recording medium can be a flash memory, a hard disk, or another known recordable medium.

(D) Also, in the above embodiments, the liquid crystal monitor 270 was given as an example of a display component, but the present invention is not limited to this. For example, the display component can be an EVF (electrical viewfinder), an organic EL display, or another known monitor capable of display.

(E) Also, in the above embodiments, the specific target was the human face X, but the present invention is not limited to this. For example, the specific target can be an entire human body, a specific individual, a pet or other animal, or any other object. Also, if the digital video camera has a touch panel, the person, animal, or object specified by the user on the touch panel interface can be used as the specific target.

(F) Also, the cropped region decision component 193 pertaining to the above embodiments decided the cropped region Y by enlarging the rectangular region y surrounding the human face X two times horizontally and vertically, but the present invention is not limited to this. The cropped region decision component 193 may decide the cropped region Y to be a region that is M times (M>0) the size of the face X, using the position of the face X as the center of the cropped region Y. In this case, if M is a relatively small value, the face X will account for a relatively large proportion of the recording image B. On the other hand, if M is a relatively large value, the face X will account for a relatively small proportion of the recording image B, and a relatively large region around the face X will be included in the recording image B. The above is the same regardless of whether the specific target is a person, a specific individual, an animal, or an object.

(G) Also, in the above embodiments, the warning image D, which prompted the adjustment of the imaging direction, was given as an example of a warning image, but the present invention is not limited to this. For example, the warning image may be “right,” “left,” “up,” “down,” and other such words or text may be used, so long as the user is notified of a change in the imaging direction and the new direction to be changed to. If the digital video camera has a speaker, a warning sound may be emitted instead of using a warning image. In this case, the controller may be equipped with a voice controller as the warning component. Also, if the digital video camera has an LED or other such light emitting device, warning light may be emitted instead of using a warning image. In this case, the controller may be equipped with a light emission controller as the warning component.

(H) Also, although not directly mentioned in the above embodiments, the cropped region decision component 193 may correct the cropped region Y according to the movement speed of the specific target. In this case, if the specific target is moving relatively slowly, the cropped region Y is corrected smaller, and if the speed is relatively high, the cropped region Y is corrected larger. When the cropped region Y is corrected smaller, there is less extra time from the start of the display of the warning image D until frame-out, but there may be enough time if the movement speed is low. Conversely, if the movement speed of the specific target is high, there will be more extra time until frame-out if the cropped region Y is made larger.

(I) Also, in the above embodiments, the annular rectangle region Z was given as an example of the specific portion of the frame image A, but the present invention is not limited to this. The shape and size of the specific portion can be set as desired. Also, the specific portion may be the outer edge of the frame image A. In this case, when the cropped region Y exceeds the rectangular boundary of the frame image A, that is, when part of the cropped region Y has framed-out, a warning image is displayed. Here again, if the cropped region Y is set large, the user can adjust the imaging direction before the face X goes out of frame.

(J) Also, in the above embodiments, the digital video camera was one that did not store frame image data, but frame image data may be stored. Furthermore, the digital video camera may store position coordinate data indicating the position coordinates of the cropped region Y in the frame image A, with this data being associated with frame image data. In this case, the user can zoom in and out on a regenerated image by using position coordinate data. Accordingly, the user can manually zoom in on the face X in reproduction mode even through the face X has not been detected accurately.

(K) Also, in the above embodiments, the cropped image P has a size of 960 pixels horizontal×540 pixels vertical, whereas the recording image B has a size of 1920 pixels horizontal×1080 pixels vertical. Specifically, the recording image data generation component 195 acquires recording image data by subjecting cropped image data to interpolation processing, but this is not the only option. The recording image data generation component 195 may acquire recording image data by subjecting the cropped image data to thinning processing. The resolution of the recording image B here will be lower than the resolution of the cropped image P.

Similarly, in the above embodiments, the recording image B has a size of 1920 pixels horizontal×1080 pixels vertical, whereas the displaying image C has a size of 320 pixels horizontal×240 pixels vertical. That is, the displaying image data generation component 196 acquires displaying image data by subjecting the recording image data to thinning processing, but this is not the only option. The displaying image data generation component 196 may acquire the displaying image data by subjecting the recording image data to interpolating processing. The resolution of the displaying image C here will be higher than the resolution of the recording image B.

Thus, the resolution of the various images given in the above embodiments is nothing but an example, and can be suitably set according to the resolution of the CCD image sensor 180, the liquid crystal monitor 270, an external display, or the like. Therefore, the resolution of the recording image B and the displaying image C may be the same as the resolution of the cropped image P. In this case, the cropped image data can be used directly as recording image data and displaying image data.

(L) Also, in the above embodiments, the cropper 194 cropped out the cropped image P from the frame image A, but the present invention is not limited to this. The cropper 194 may crop out the cropped image P from an image obtained by subjecting frame image data to image processing (such as a frame image A that has undergone enlargement processing, or a frame image A that has undergone reduction processing).

(M) Also, in the above embodiments, the displaying image data was generated by processing of recording image data generated on the basis of cropped image data, but the present invention is not limited to this. The displaying image data may be generated on the basis of cropped image data. Therefore, the displaying image C may be an image displayed on the basis of cropped image data.

### INDUSTRIAL APPLICABILITY

The present invention can be applied to digital video cameras, digital still cameras, and other such imaging devices because the user can be notified when there is the risk that a specific target will be framed out of the imaging area.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention should be interpreted relative to an imaging device.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. An imaging device comprising:
an imaging component configured to generate frame image data by capturing a subject image;
a cropper configured to generate cropped image data used to produce a cropped image, the cropped image data being generated based on a cropped region of a frame image produced according to the frame image data;
a monitor configured to display a through-image by sequentially displaying the cropped images based on the cropped image data; and
a warning component configured to issue a warning when the cropped region overlaps a specific portion of the frame image.

2. The imaging device according to claim 1, wherein the warning component is a display controller configured to simultaneously display a warning image and the through-image on the monitor.

3. The imaging device according to claim 2, wherein
the warning image is an arrow prompting the adjustment of an imaging direction.

4. The imaging device according to claim 1, wherein
the specific portion is an annular region located within a specific distance from the outer edge of the frame image.

5. The imaging device according to claim 1, wherein
the specific portion is the outer edge of the frame image.

6. The imaging device according to claim 1, further comprising:
a specific target detector configured to detecting a position and size of a specific target within the frame image.

7. The imaging device according to claim 6, further comprising:
a cropped region decision component configured to decide a position and size of the cropped region based on the position and size of the specific target.

8. The imaging device according to claim 7, wherein
the cropped region decision component is configured to corrects the chosen size of the cropped region based on the rate of change of the position and size of the specific target.

9. The imaging device according to claim 1, further comprising:
a reduced frame image data generation component configured to generate reduced frame image data using the frame image data, the reduced frame image data corresponding to a reduced frame image obtained by reducing the frame image
the reduced frame image and the through-image being simultaneously displayed on the monitor.
